(19) United States
(12) Patent Application Publication
(10) Pub. No.: US 2007/0143706 A1
(43) Pub. Date: Jun. 21, 2007

(54) Variable-speed scrollbar

(75) Inventor: Johan C. Peters, Sankt-Leon Rot (DE)

Correspondence Address: KENYON & KENYON LLP, 1500 K STREET N.W., WASHINGTON, DC, 20005, US

(73) Assignee: SAP AG

(21) Appl. No.: 11/304,763

(22) Filed: Dec. 16, 2005

(51) Int. Cl. G06F 9/00

(52) U.S. Cl. 715/786

(57) ABSTRACT

Embodiments of the present invention relate to a variable-speed scrollbar that enables a user to speed up or slow down scrolling by manipulating an accelerator/decelerator field. For example, by changing the position of a speed selector within the accelerator/decelerator field, the user can speed up or slow down scrolling as desired.

### BACKGROUND OF THE INVENTION

Scrollbars for the viewing of electronic documents are known. In Microsoft Word, for example, the scrollbar takes the form of a vertical strip along an edge of a screen display. Clicking with a mouse on arrows at either end of the strip causes the content of the display to move up or down. The same effect can be accomplished by moving a sliding button within the strip using the mouse.

Limitations in the above-described functionality can be frustrating to a user. When viewing a large document, for example, the user may want to proceed quickly through long stretches of the document, while still viewing it. While it is possible using the known sliding button functionality to jump quickly to different parts of a document, the quick jumps do not let the user see what content is being skipped over. To scroll at a viewable pace through the document using the sliding button, the user must manipulate the mouse in a somewhat awkward and tedious operation—holding down a mouse button while repetitively rolling the mouse in a straight line along a surface.

On the other hand, with the scrollbar arrows, a user need not perform the above-described operations. Instead, the user can simply keep an arrow activated and the document will scroll up or down. However, the document moves at a fixed speed, which can be frustrating if, as mentioned earlier, the user wants to go through long stretches quickly.

### BRIEF DESCRIPTION OF THE DRAWINGS

FIGS. 1A-1C show a variable-speed scroll bar according to embodiments of the present invention;

FIG. 2 shows a computer system according to embodiments of the present invention; and

FIG. 3 shows a process flow according to embodiments of the present invention.

### DETAILED DESCRIPTION

Embodiments of the present invention address the above-described concerns. The embodiments relate to a variable-speed scrollbar that enables a user to speed up or slow down scrolling by manipulating an accelerator/decelerator field. For example, by changing the position of a speed selector within the accelerator/decelerator field, the user can speed up or slow down scrolling as desired. The user therefore need not perform the awkward manipulations associated with a sliding button, and is not limited to the fixed scrolling rate of the arrow functionality.

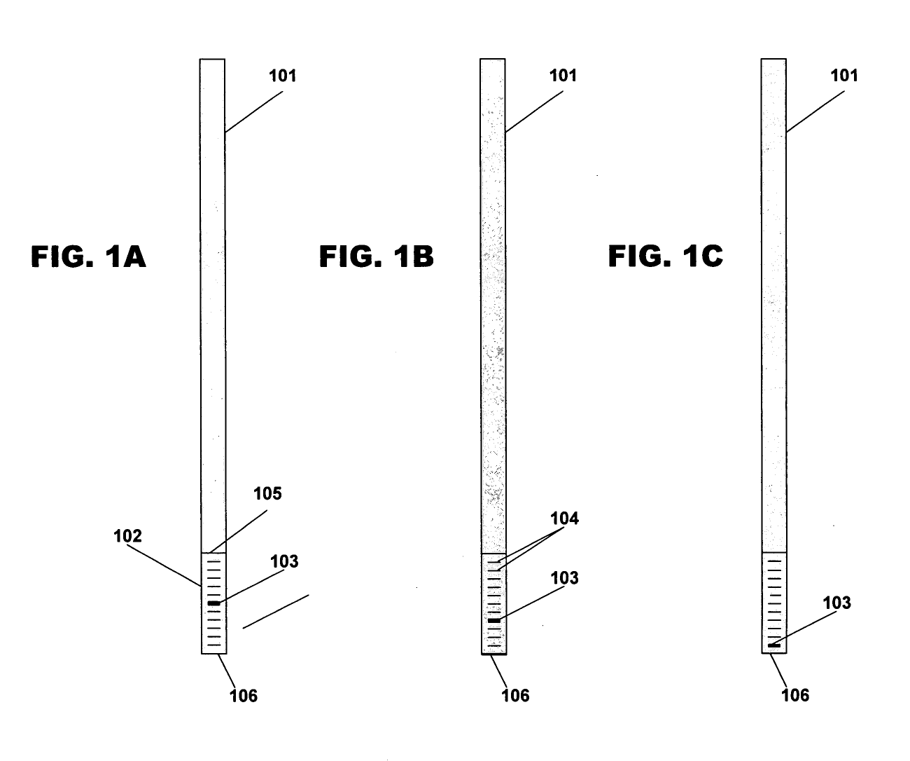

FIG. 1A shows a representation of a variable-speed scrollbar 101 according to embodiments of the present invention. An accelerator/decelerator field 102 may be defined within the scrollbar 101. The accelerator/decelerator field 102 may be manipulated to speed up or slow down scrolling, for example by pointing, clicking and dragging with a mouse. Specifically, a speed selector 103 may be slidable or displaceable within the accelerator/decelerator field. In FIG. 1A the selector 103 is in a central or neutral position. When the selector is in the neutral position, the corresponding display may be stationary—i.e., no scrolling is performed. Displacing the selector away from the neutral position toward either an upper bound 105 or a lower bound 106 of the accelerator/decelerator field 102 may cause scrolling to occur at a selected speed. The accelerator/decelerator field 102 may include a number of gradations 104 representing increments or decrements in speed to which a user can refer to judge how far to displace the selector. In FIG. 1B, the selector 103 is displaced about halfway from the neutral position toward the lower bound 106, indicating a medium scrolling speed. In FIG. 1C, the selector 103 is at the lower bound 106, representing scrolling that is occurring at a maximum speed.

Scrolling may be slowed by moving the selector back toward the neutral position. Scrolling may stop altogether when the selector is again at the neutral position, and then be resumed, and have its speed increased by, say, moving the selector toward the upper bound 105.

Scrolling may continue while a “click-and-hold” operation is maintained. Scrolling may be stopped by a de-activation operation, such as releasing a mouse button that had previously been held down to activate scrolling. In this event, the selector 103 may automatically return to the central, neutral position. The return may be instantaneous or may occur over some predetermined length of time—e.g., the selector 103 may glide back to the neutral position over an interval of, say, one second. The option may further be provided of allowing scrolling to continue at a selected speed even without continuing to manually activate scrolling (e.g., a user may release the mouse button but scrolling will continue at a selected speed). With this option, scrolling may then be stopped by some subsequent manual operation such as moving back to the neutral position or by clicking on the neutral position of the selector.

The variable-speed scrollbar according to embodiments of the present invention may be incorporated into any kind of computer display, such as a display of a word processing document or web page. The speed control may be integrated with a conventional vertical scrollbar. For example, the accelerator/decelerator field 102 may be provided below or in a lower part of a conventional vertical scroll bar of an application window. In embodiments of the invention, the accelerator/decelerator field 102 may be hidden in normal operation, but may “pop up”—i.e., become visible and usable, upon some operation such as right-clicking on a conventional scrollbar.

Behavior of a display including the variable-speed scrollbar, including scrolling speed as controlled by the accelerator/decelerator field, may be governed at least in part by computer-executable instructions according to embodiments of the present invention. The instructions may generate, possibly in association with conventional code that controls aspects of a display's appearance, a display on a display device, where the display includes a variable speed scrollbar comprising an accelerator/decelerator field according to embodiments of the invention. Further, the instructions, or conventional code that interfaces with the instructions, may receive input signals from a mouse or other input device and perform corresponding operations. For example, a user may activate scrolling by positioning a pointer or cursor or other positional indicator over the speed selector of accelerator/decelerator field, and clicking and dragging the selector to displace it away from a neutral position. Such operations may generate activation and speed selection signals to the instructions, or conventional code that interfaces with the instructions.

In response to the signals, the instructions, or conventional code that interfaces with the instructions, may cause the display to scroll across a screen of the display device at a selected speed. Subsequently, the user may use the input device to displace the selector again, for example by dragging the selector either away from or toward the neutral position. In response to signals from the input device indicating a displacement of the selector from its previous position, the instructions, or conventional code that interfaces with the instructions, may cause the display to scroll faster or slower across the screen. Many forms of algorithmic logic could be suitable to determine a change in scrolling rate resulting from the displacement. For example, an upper speed limit for scrolling may be established. This may be mapped to the upper and lower bounds of the accelerator/decelerator field. Positions within the upper and lower bounds may be mapped to corresponding speeds between a rate of zero (no scrolling) and the upper speed limit, for example in a look-up table or by equations calculated dynamically. A change in scrolling rate may be computed according to the mapping based on a change in position. The change in the scrolling rate may, for example, be proportional to a displacement of the speed selector from a previous position.

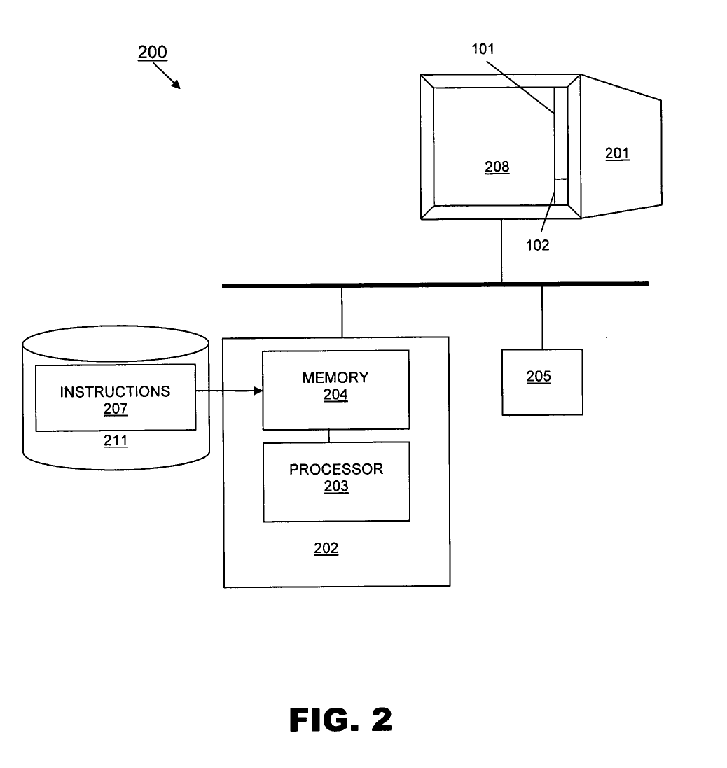

FIG. 2 shows a system 200 wherein embodiments of the present invention may find advantageous application. The system 200 may comprise a display device 201. The display device 201 may be coupled to a computer 202 comprising a processor 203 and memory 204. The computer 202 may further be coupled to an input device 205 such as a mouse or keyboard.

Computer-executable instructions 207 according to embodiments of the present invention may be stored on any machine-readable medium 211, such as RAM (random access memory), ROM (read-only memory), floppy disk, fixed disk, CD-ROM, magnetic tape and the like. The instructions may be loaded from the machine-readable medium 211 into the memory 204 for execution by the processor 203. As noted previously, the instructions may interface with conventional code that controls aspects of a display's appearance.

The instructions 207, or conventional code that interfaces with the instructions 207, may generate a display 208 on the display device 201. The display 208 may include a variable-speed scrollbar 101 according to embodiments of the present invention. With the input device 205, a user may activate features of the scrollbar, such as activating the accelerator/decelerator field 102 and speeding or slowing scrolling by displacing the selector 103 within the upper and lower bounds of the accelerator/decelerator field. These activities may generate signals from the input device 205 that are detected by the computer 202. The instructions 207, or conventional code that interfaces with the instructions 207, may be responsive to the signals detected by the computer 202 and generate a corresponding display on the display device 201.

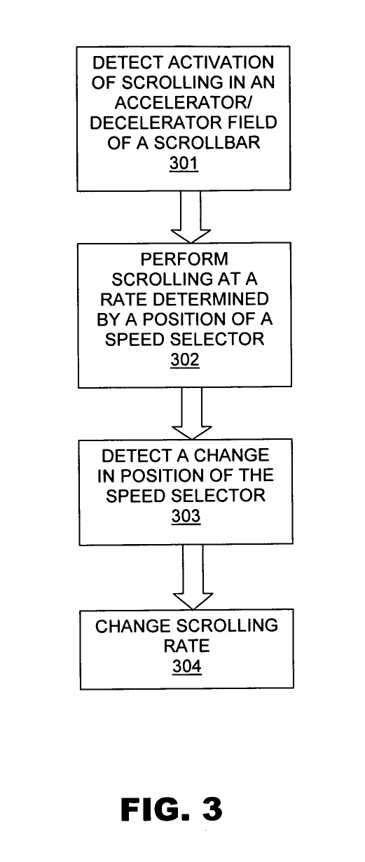

FIG. 3 shows a process flow according to embodiments of the present invention. As shown in block 301, an activation of scrolling in an accelerator/decelerator field of a computer display may be detected. In response, scrolling may be performed at a rate determined by a position of a speed selector in the accelerator/decelerator field, as shown in block 302.

Subsequently, signals indicating a change in position of the speed selector may be detected, as shown in block 303. In response, the scrolling rate may be changed, as shown in block 304. The change in scrolling rate may be in proportion to the change in position

As noted earlier, upon cessation of a manual activation of the scrolling, the scrolling may nevertheless continue at a selected rate until stopped by some subsequent operation. On the other hand, the scrolling may stop immediately upon cessation of a manual activation of the scrolling.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method comprising:
generating a display on a display device, the display including a variable speed scrollbar comprising an accelerator/decelerator field; and
in response to manipulation of the accelerator/decelerator field, speeding or slowing a scrolling rate of the display.

2. The method of claim 1, wherein the accelerator/decelerator field comprises a speed selector, and a change in the scrolling rate is caused by displacement of the speed selector from a previous position.

3. The method of claim 2, wherein the change in the scrolling rate is proportional to the displacement of the speed selector from the previous position.

4. The method of claim 1, wherein the scrolling occurs at a selected speed even upon a cessation of manual activation of scrolling.

5. A machine-readable medium storing instructions to perform a method according to claim 1.

6. A system comprising:
a display device; and
a computer coupled to the display device, the computer to generate a display on the display device, the display including a variable-speed scrollbar comprising an accelerator/decelerator field;
wherein the accelerator/decelerator field is responsive to manipulation thereof to speed or slow a scrolling rate of the display.

7. The system of claim 6, further comprising an input device, the input device to generate signals to the computer indicative of manipulation of the accelerator/decelerator field.

8. The system of claim 6, wherein the accelerator/decelerator field comprises a speed selector to select a scrolling rate.

9. The system of claim 8, wherein the speed selector is displaceable within the accelerator/decelerator field to change a scrolling rate.

10. The system of claim 6, wherein the accelerator/decelerator field comprises gradations corresponding to increments or decrements in scrolling rate.

11. A method comprising:
detecting activation of scrolling in an accelerator/decelerator field of a computer display; and
in response, performing scrolling at a rate determined by a position of a speed selector in the accelerator/decelerator field.

12. The method of claim 11, further comprising:
detecting a change in position of the speed selector; and
in response, changing the scrolling rate.

13. The method of claim 12, wherein the change in scrolling rate is proportional to the change in position.

14. A machine-readable medium storing instructions to perform a method according to claim 11.

15. A navigation control tool within a computer application, comprising:
a displacement control window having a neutral position provided between a pair of respective bound positions,
an interactive object provided within the displacement control window initially at a neutral position, and
a scroll control, responsive to displacement of the interactive object away from the neutral position, to cause scrolling of the document in an application window in a direction of the displacement.

16. The document navigation control of claim 15, wherein a speed of the scrolling is defined by a magnitude of displacement away from the application window.

17. The document navigation control of claim 15, wherein the document navigation control is provided below a vertical scroll bar of an application window.

18. The document navigation control of claim 15, wherein the document navigation control is provided as a hidden control, which appears as pop up control in response to user interaction with a vertical scroll bar of an application window.

19. The document navigation control of claim 15, wherein the document is a word processing document.

20. The document navigation control of claim 15, wherein the document is a web page.

21. The document navigation control of claim 15, wherein in response to operator release of the interactive object, the interactive object returns to the neutral position and the scrolling ceases accordingly.
